(19) United States
(12) Patent Application Publication
(10) Pub. No.: US 2008/0125887 A1
(43) Pub. Date: May 29, 2008

(54) EVENT CONTEXT DATA AND AGGREGATION FOR INDUSTRIAL CONTROL SYSTEMS

(75) Inventor: Clark L. Case, Phoenix, AZ (US)

Correspondence Address: ROCKWELL AUTOMATION, INC./(AT), ATTENTION: SUSAN M. DONAHUE, E-7F19, 1201 SOUTH SECOND STREET, MILWAUKEE, WI, 53204, US

(73) Assignee: ROCKWELL AUTOMATION TECHNOLOGIES, INC., Mayfield Heights, OH (US)

(21) Appl. No.: 11/535,761

(22) Filed: Sep. 27, 2006

(51) Int. Cl. G06F 13/00; G05B 15/00

(52) U.S. Cl. 700/83; 719/318; 700/1

(57) ABSTRACT

A data processor for an industrial automation system is provided. An event component generates an initial message from an industrial control system component, where the initial message is based in part on one or more automatically detected conditions. A context component enables data to be added to the initial message to facilitate post processing of system events.

### TECHNICAL FIELD

The subject invention relates generally to industrial control systems and more particularly to components that dynamically apply context data to alarms or events, where such data can be aggregated, analyzed, and directed to parties in a focused manner in accordance with the context data.

### BACKGROUND

Industrial control systems generate a plurality of data—both for internal consumption by the systems and for external use such as for maintenance personnel or plant management. In one example of such control system data, modern control systems generally provide status relating to diagnostic aspects of the system. This can include fault bits reflecting hardware detected failures such as watchdog timer values and can include software recorded information such as communications retry counters or process event data including detected alarm conditions. Often times, programmable logic controller (PLC) programmers write custom PLC code to monitor diagnostic bits or data and then write specialized control programs to respond to such data. This type activity can be very time consuming to develop and test an effective control solution that responds in accordance with detected diagnostic behavior. In addition, obtaining timely, useful and human-readable diagnostic data from the PLC or associated system can also be problematic. Moreover, most diagnostic bits or status elements that are provided by PLC's are relatively static in nature. Thus, controller programs that respond to such information generally are written in a reactive mode, whereby a potentially disruptive situation may have already occurred before any type of corrective action is performed.

One mechanism that has been employed to communicate control system status data relates to alarm and event generation/transmission. Generators for such alarms or events can be triggered from some occurrence in the control system and can be set to automatically fire upon a plurality of varying conditions. For example, alarms can be set up to generate a data packet relating to substantially any occurrence in the control system. The alarms can be generated from processor status events such as low memory, communications errors, logic errors, unauthorized access conditions, buffer conditions, watchdog events, and so forth. Similarly, programmers can define event ranges for control variables, where if a data value is detected outside of a given range, an event can be generated that indicates such detection. Alarms or events can be defined with basic status information such as a time the alarm was generated or an address that generated the alarm. It is noted that alarms can be categorized as a particular type of event.

The type of basic status information that can be associated with an alarm is unsatisfactory for many applications. Generally, this type of basic information relating to the time or name of an alarm is static in nature and is not organized in a manner suitable for post processing of the data. For example, if five hundred alarms or events were generated for a control system over the past week, some of these items may apply to routine maintenance conditions that would be applicable for plant operators whereas other type of data may be required for regulatory matters. Since the data is generated and collected in a haphazard manner (e.g., not sorted per requirements of system or user), it can be exceedingly difficult to find relevant data let alone to try and understand if a large amount of collected data is important in the first place.

Another problem with the limited nature of generated system status data relates to reporting of such data for regulatory concerns. Many systems fall under significant regulatory constraints, where status data generated from the system is to be logged and categorized in order to satisfy a specific regulation. This may involve many layers of regulation that are now being imposed on automated industries to ensure compliance to applicable standards. To document that these requirements are being adhered to, often one or more signatures are required by various personnel to satisfy the respective requirements. Currently, users may have to sift though a plurality of data and records to find applicable data that may be relevant for reporting a particular condition. Often times, after such searching though data, it is determined that no particular record is applicable over a given timeframe, thus valuable resources are lost attempting to analyze and determine such data.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

Context data is added to standard alarm and event messages to facilitate efficient processing of the messages. This includes the ability to generate reports that are specialized and focused to the user of the report rather than sifting though a plurality of unrelated messages or data. In one aspect, standard alarm or event messages are post-processed with context data, where such data is employed to drive report generators and aggregators that are focused to an activity, a user type, or other function. Such context data can indicate the source of an event, an event process, a phase associated with an event, a batch process, a program or procedure call, or a user who may have been involved at some portion of a process that generated the event or subsequently analyzed the event. The context data allows more focused decisions to be made regarding an alarm or event source/condition while mitigating the amount of extraneous processing for unrelated data (e.g., show all alarms related to context A and hide alarm data related to context B). Thus, in one aspect, context data allows users to focus on the data of interest including the reasons why such data may be of interest while mitigating the need to sort through data unrelated to the condition at hand.

In previous systems, data may have been tagged as to the time of an event, a name of an event, or an address where the event occurred, where such fields for tagging were fixed at a certain number such as three. This tagging procedure was basically static in that once the alarms or events were generated, they could be collected for the system as a whole, yet relevant context associated with the event was missing. For example, one PLC routine may generate an alarm event yet the source for calling the routine may be associated with a plurality of different phases of a recipe or discreet process. Thus, even though it could be detected that an alarm was generated from an overall process, it was unclear which phase of the process had actually called the routine that triggered the respective alarm. By adding context data after an initial event has been generated, causes and respective solutions to problems can more effectively be determined. Also, context can continually be added during more than one post process phase. Thus, a first user could add some context to the event and that context could subsequently be updated or supplemented by other users or automated procedures. This type of aggregation of context data can be later used for report generation, system analysis, troubleshooting, and documentation for automated regulatory procedures.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating context data processing for an industrial automation system.

FIG. 2 is a diagram illustrating data context additions to event messages.

FIG. 3 is a diagram illustrating supplemental data being added to an event message over the lifetime of the message.

FIG. 4 is a diagram illustrating an example event processor and message annotator system.

FIG. 5 is a diagram illustrating example report generation and data mining aspects for context data.

FIG. 6 is a diagram illustrating and example control system and user interface operating with context data.

FIG. 7 is a flow diagram illustrating an automated context data annotation process.

FIGS. 8-11 illustrate a common data model that can be employed for context data annotation.

### DETAILED DESCRIPTION

Systems and methods are provided to facilitate alarm and event data processing in an industrial control system environment, where context is provided after an event has been generated to more effectively process and analyze the event. In one aspect, a data processor for an industrial automation system is provided. An event component generates an initial message from an industrial control system component, where the initial message is based in part on one or more automatically detected conditions. A context component enables data to be added to the initial message to facilitate post processing of system events.

It is noted that as used in this application, terms such as “component,” “interface,” “event,” “context,” and the like are intended to refer to a computer-related entity, either hardware, a combination of hardware and software, software, or software in execution as applied to an automation system for industrial control. For example, a component may be, but is not limited to being, a process running on a processor, a processor, an object, an executable, a thread of execution, a program and a computer. By way of illustration, both an application running on a server and the server can be components. One or more components may reside within a process and/or thread of execution and a component may be localized on one computer and/or distributed between two or more computers, industrial controllers, and/or modules communicating therewith.

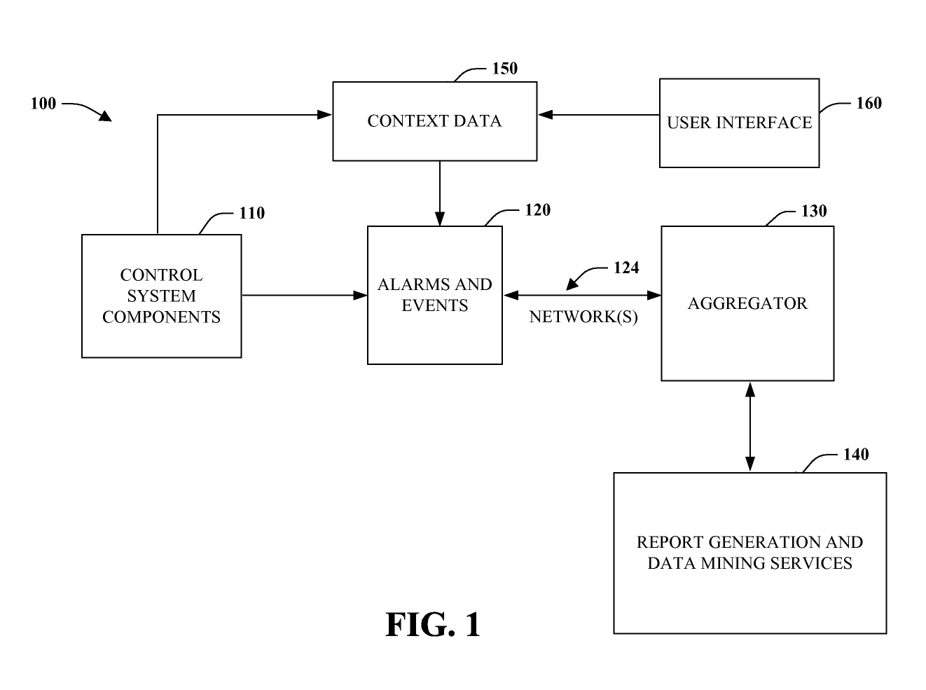

Referring initially to FIG. 1, a system 100 illustrates context data processing for an industrial automation system. The system 100 includes one or more control system components 110 that have the ability to generate an alarm or event 120 (also referred to as event 120) based on some condition detected within or across the system 100. The event 120 can be sent across a network 124 and collected by an aggregator 130 including a database or computer component, where events from across the system 100 via the network can be stored or logged. A report generation and data mining component 140 can be provided to generate reports or perform analysis relating to management and troubleshooting of the system 100. Such reports can also be applied to maintain compliance with one or more regulatory procedures that the system 100 may be subject to. In general, system context data 150 can be added to supplement standard alarm and event messages 120 in order to facilitate efficient post-processing of such messages. Context can be automatically added after the event 120 has been generated via the control system components 110 and/or in accordance with a user interface 160.

The report generation and data mining services 140 allow reports to be generated that are specialized and focused to the user of the report rather than sifting though a plurality of unrelated messages or data. In one example, standard alarm or event messages 120 are post-processed and supplemented with context data 150, where such data is employed to drive report generators 140 and aggregators 130 that are focused to an activity, a user type, or other function such as a regulatory compliance procedure. Such context data 150 can indicate the source of an event, an event process, a phase associated with an event, a batch process, a program or procedure generating the event, or a user who may have been involved at some portion of a process that generated the event or subsequently analyzed the event 120. Various users can employ the user interface 160 (or interfaces) to post-annotate messages associated with the event 120 and subsequently apply context data 150 to the event.

The context data 150 allows more focused decisions to be made regarding the alarm or event source/condition that generated the event 120 while mitigating the amount of extraneous processing for unrelated data. For example, this could include displaying all alarms or subset of alarms relating to one context while hiding alarm data related to another context. Thus, in one aspect, context data 150 allows users to focus on the data of interest including the reasons why such data may be of interest while mitigating the need to sort through data unrelated to the conditions that generated the event 120.

In previous systems, data may have been tagged as to the time of an event, a name of an event, or an address where the event occurred. This tagging procedure was basically static in that once the alarms or events were generated, they could be collected for the system as a whole, yet relevant context associated with the event was missing. For example, one control component 110 routine may generate an alarm event 120 yet the source for calling the routine may be associated with a plurality of different phases of a recipe or discreet process. Thus, even though it could be detected that an alarm was generated from an overall process, it was unclear which phase of the process had actually called the routine that triggered the respective alarm. By adding context data 150 after an initial event 120 has been generated, causes and respective solutions to problems can more effectively be determined. Also, context data 150 can continually be added during more than one post process phase. Thus, a first user could add some context data at 160 to the event 120 and that context could subsequently be updated or supplemented by other users (or automated procedures at 110) via the user interface 160 (or other interfaces having network access to add data to the event 120). This type of aggregation of context data 150 can be later used at 140 for report generation, system analysis, troubleshooting, and documentation for automated regulatory procedures.

It is noted that in an alternative aspect, the context data 150 can be added according to a common data model that supports various structured data hierarchies in the system 100 or across an enterprise. Thus, context data 150 may be added during one or more phases of event processing that may be associated with an area or portion of the common data model. Such interactions with the model can be employed as context data 150 for the given event 120, where all interactions with the common data model can be subsequently collected and analyzed at the aggregator 130 or analyzed via the report generation and data mining services 140. The common data model that can be employed in conjunction with the context data 150 will be described in more detail below. In another aspect, the system 100 can include a data generator for an industrial control system. This includes means for generating at least one event condition 120 in an industrial control system (e.g., control system component 110) and means for supplementing the alarm or event condition with context data 150 (e.g., component 120 or interface 160). This can also include means for aggregating (e.g., component 130) the context data 150 in the system 100 and means for generating a report (e.g., component 140) in the system from the context data.

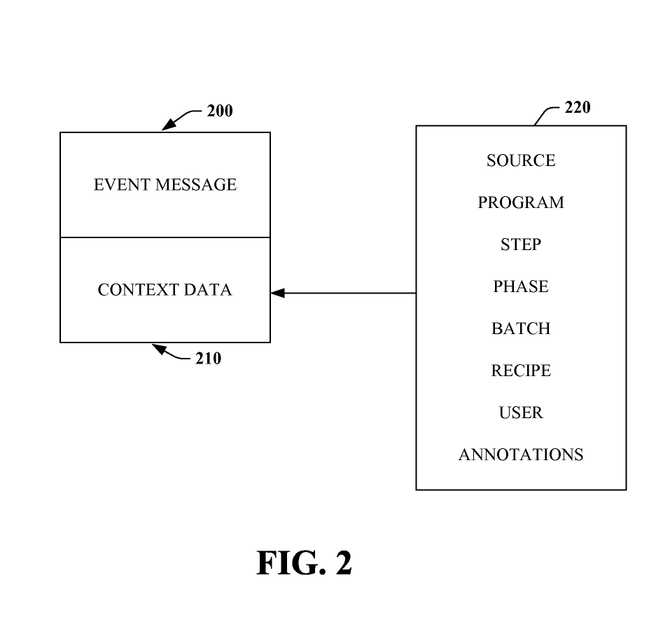

FIG. 2 illustrates example data context additions to event messages. At 200, an event message is generated from a control component, where initially the message may include a message name, machine name, and time stamp for when the message was generated. Event messages can be alarms or based on some detected condition such as a program overflow. After generation of the initial message 200, context data 210 can be added or provided as a supplement to the original message 200. Some examples of the context data 210 are illustrated at 220. These examples can include source information indicating where the control component was executing at the time of the original event message 200. Source provides more information than just specifying a machine that generated a message. For example, a code module executable on a machine controller may be called by a plurality of other modules in a process. The code module may be the originator of the event message 200 yet it may be more relevant to know which other module actually called the code module. Thus, appending source or process information as context data 210 can facilitate troubleshooting and documenting the event message 200 in a more precise/efficient manner.

Other context data examples 220 can include appending information about the underlying code modules executing a given process. This can include program information relating to the logic or SFC that was involved in the message 200. Other examples 220 include step, recipe, batch, or phase information that can similarly be appended to the event message 200 as context data 210. For example, in a batch process, if a controller were to generate the event message 200, a batch server coupled to the controller could append step, phase, batch, and/or recipe related information at 210 that was available at the time and/or after generation of the event message 200. Another example 220 includes user information that can be generated as context data 210. This can include information relating to what users were accessing a machine at the time or after an event message 200 was generated. This can also include annotations that have been applied as context data from one or more users as will be described in more detail below.

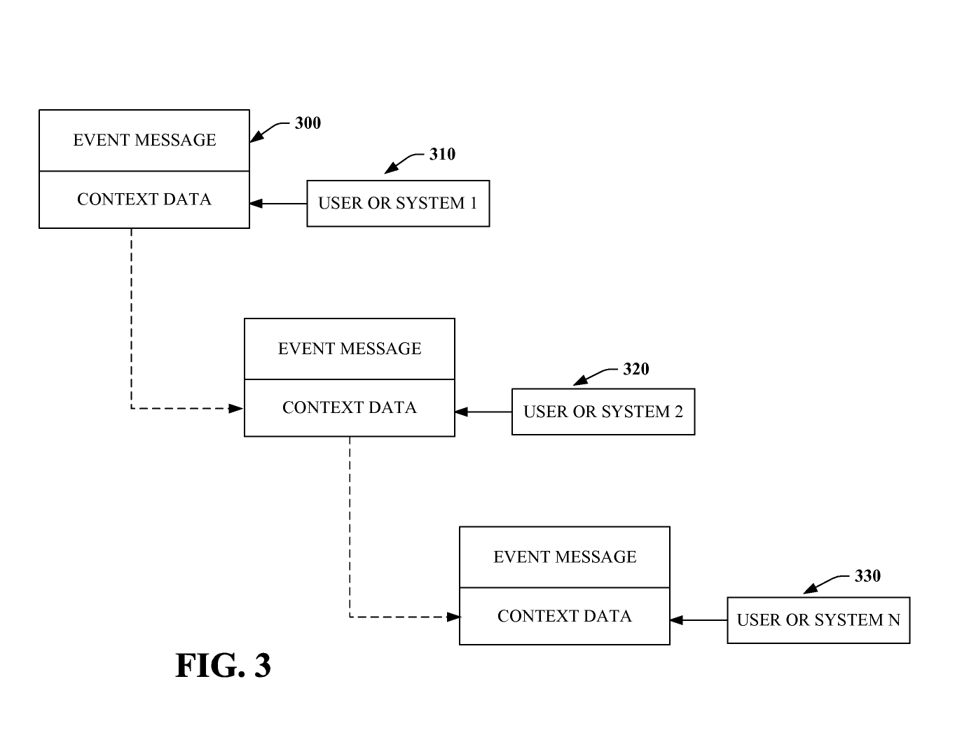

FIG. 3 illustrates supplemental data being added to an event message over the lifetime of the message. At 300, an initial alarm or event message is generated by some component in a control system. At 310, context data is updated for the event message by a user or system. For example, the initial system that generated the event message 300 may have annotated information at 310 relating to the phase or batch process that was operational during or after the event was generated. Similarly, a user who was operating the phase or batch process may have their identification (e.g., name or number) appended to the event message 300. In another example, the user at 310 may be the first one in a chain of users or systems to initially receive the event message 300. That user may then analyze the relevant data that has been generated thus far, append more data to the message at 310, and also indicate their identity at 310 for later system logging and analysis.

As shown, a subsequent system or user may append data to the message 300 and this is illustrated at 320. Thus, as time goes by, other users or systems can annotate context data such as at 320. These context annotations can continue through a user or system N illustrated at 330, where N is represented as an integer. It is to be appreciated that context data can be updated in a concurrent manner or a serial manner as illustrated at 310 through 330. For example, the original message 300 may be generated and subsequently annotated by a processor at 310. This message 300 may also alert a plurality of other users or systems causing them to begin to analyze the message event and context data 310, if any thus far. These respective users and systems 320, 330 may have buffer copies of the original event message 300 and also any context data generated thus far. From the buffered copies, context data can be generated and appended to the event in a parallel manner if desired. As can be appreciated, the last receiver or aggregator of such message event 300 can be tasked with appending/updating a final version of the event message with the latest copy of all annotations and context data 310-330 that have taken place thus far. Other examples may include a more serial process where one system or user annotates context data which is followed by a subsequent system or user.

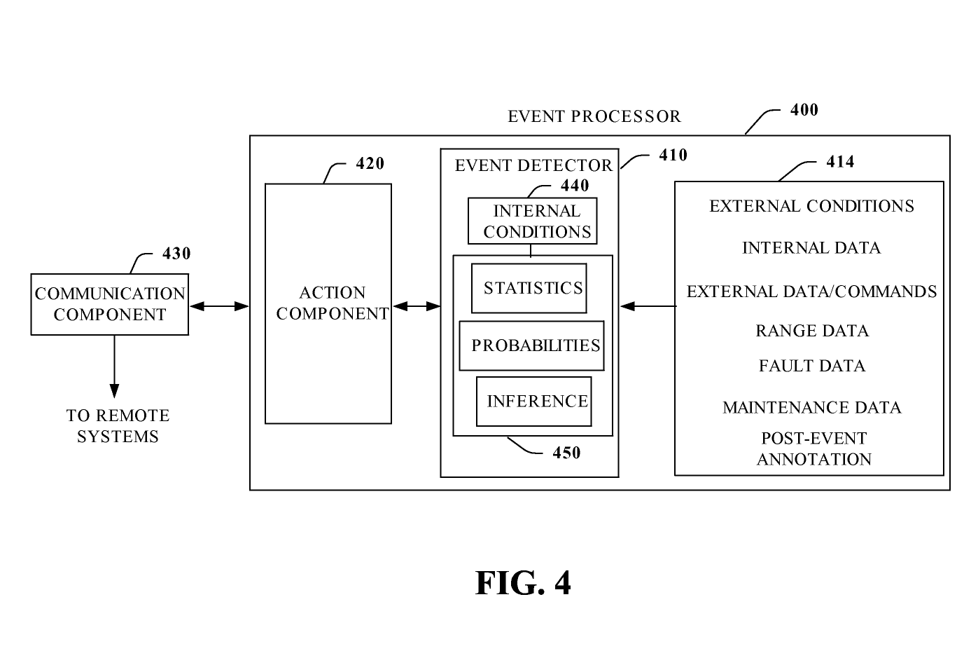

Referring now to FIG. 4, an example event processor and message annotator 400 is illustrated in accordance. An event detector 410 monitors or receives a plurality of event inputs at 414 to generate an event that drives an action component 420. The action component 420 maps one or more maintenance/event actions to one or more of the event inputs 414 and/or internally detected events that are described below. Actions can include configuring a schema, annotating events with context data, and notifying a remote user of the detected events 414 via a communications component 430 providing web or other type data access, for example. Actions can include pushing data files such as an MPEG or JPEG file relating to the associated event, and subsequently employing such files as annotation or context data. Actions can also include automated actions such as ordering a device or component based on a detected event. Additionally, maintenance documentation or data can be provided to facilitate troubleshooting of a control system.

At 414, event inputs can include various types. External conditions can be monitored such as monitoring status or data from a remote network or back plane. Internal data such as from components interfacing to a processor (e.g., memories, interrupts, busses, peripherals, latches, clocks and so forth) and associated data can be monitored for potential failures or irregularities. External data events or commands can be monitored and detected at 414. This can include remote network commands to request status and/or to initiate data upgrades such as documentation or firmware. As noted above, range data (external or internal) can be monitored for values that fall outside of a predetermined range. Other type data that can be monitored at 414 include fault data or bits from diagnostic routines that may be running as part of background operations. In addition, maintenance data can be detected such that at predetermined time or date intervals, events can be triggered such as ordering and/or replacing system components on a routine basis or schedule.

In addition to the event inputs 414, the event detector 410 can determine internally generated events at 440 based upon implied or inferred conditions of system health. This can include inference, statistical, and/or probability analysis at 450 for a subset of data or inputs that is monitored for routine or modeled patterns over time. If the data subset deviates from the determined pattern, internal events can be fired that invoke one or more actions in the action component 420 such as a notification to a remote user. Data patterns can be determined in accordance with a plurality of techniques. A statistical analysis of data or inputs can include substantially any technique such as averaging, standard deviations, comparisons, sampling, frequency, periodicity and so forth.

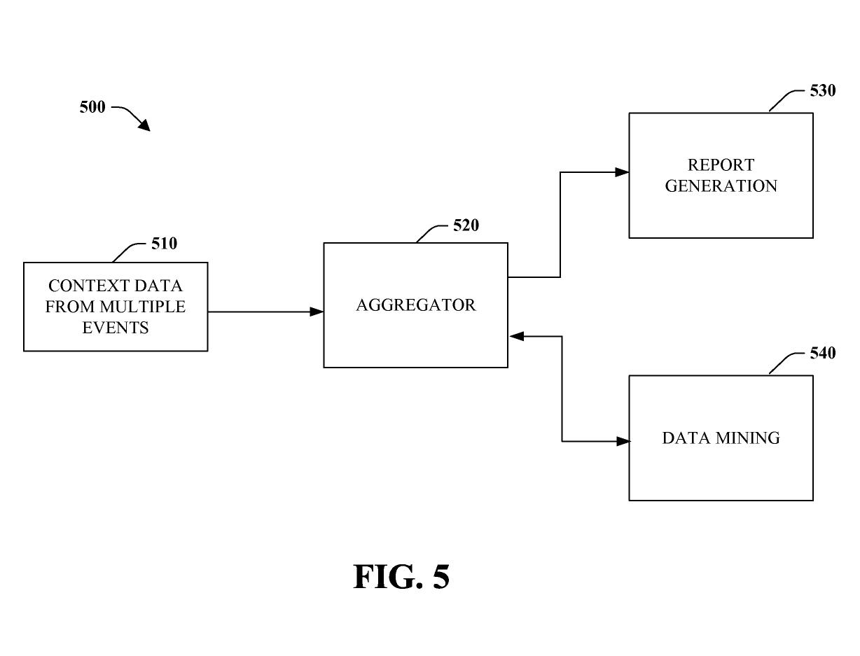

Referring to FIG. 5, a system 500 illustrates report generation and data mining aspects. Proceeding to 510, context data is generated from multiple sources, interfaces, and/or users. This includes substantially any event or alarm that has been generated by a controller, communications module, intelligent module, server, client, and so forth. As noted above, users can employ one or more interfaces to apply annotations as context data 510. At 520, the events and associated context data 510 is collected via an aggregator. This collection of data at 520 could be in a database (e.g., SQL), temporary computer file, system cache, PLC memory, network device memory, and so forth. At 530, one or more components can be employed to automatically generate reports. This can include the ability to query and filter the aggregator 520 for a desired report type or format. For example, this could include the ability to generate a report such as “Create report showing all events annotated by user X” or “Create report showing all events where user Y participated in the process that generated the event” or “Create report showing all events from process A” or “Create reports from all events from machine C but hide those events generated during phase sequence A.”

At 540, a data mining component can be provided to enable higher level analysis of context data and for performing such activities as trend analysis, quality analysis or management analysis and so forth. The data mining component 540 could employ some form of On Line Analytical Processing or OLAP that is generally applied to applications that perform multidimensional analysis which facilitates data or information to be viewed and manipulated in a more intuitive manner. For instance, in a control application, OLAP users can observe a set of performance data in many different forms without expending great software design resources. This behavior is facilitated via OLAP files or cubes that model data in multiple dimensions. A dimension is the classification of some activity in an organization or other structure with which one can measure a parameter such as a goal or business success. For example, users can track output data against product or controller data over a given period of time.

Generally, there are two types of dimensions that applications can employ, regular dimensions and measures dimensions. Regular dimensions refer to the items of data that users desire to measure, for example, if an application was designed to control production output items. Another dimension includes time, such as where do these products stand now with respect to last year or last month. Measures dimensions are the numbers that appear in the analysis depending on the elements chosen from the regular dimensions. For example in a production cube, one may want to track revenue, cost, units sold, discounts, and so forth. When such data has been collected at 520 and analyzed at 540, the data may be assigned to a highly sophisticated structure referred to as a multidimensional cube, where the cube can reside in a specialized database or as a standalone file. The cube allows users to observe data in a plurality of different forms. Thus, applications can cross the respective dimensions of the cube to obtain new information which hopefully should answer questions that users may be searching for—in this example information relating to one or more aspects of a control system or enterprise as it pertains to the context data.

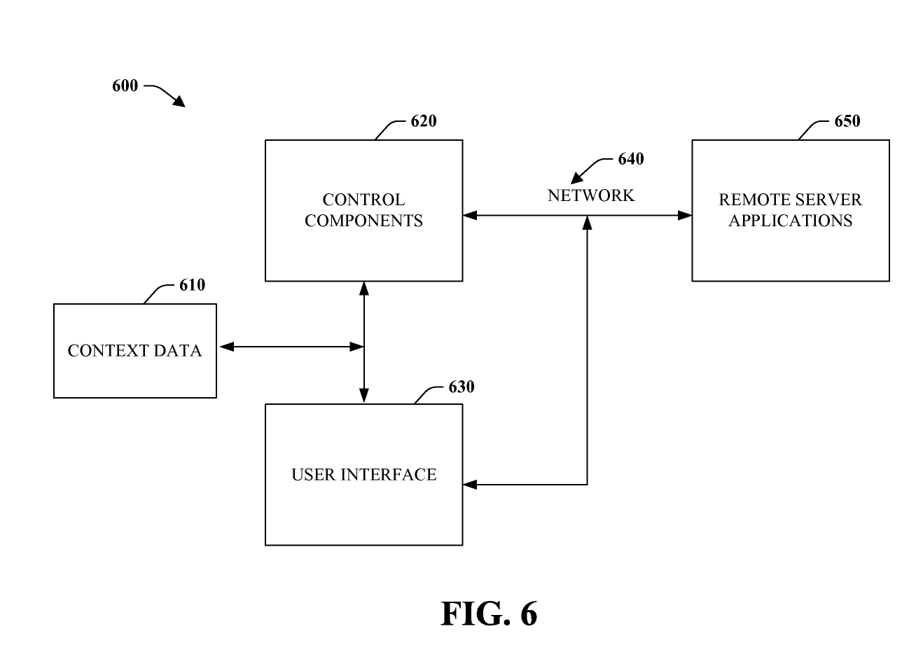

FIG. 6 illustrates an example system 600, network and user interface that can be employed with a context data 610. As shown, the context data 610 can be applied via one or more control components 620 and user interface 630. The control components 620 and interface 630 can communicate across a network 640 with one or more remote server applications. The control components 620 can include various computer or network components such as servers, clients, programmable logic controllers (PLCs), communications modules, mobile computers, wireless components, control components and so forth which are capable of interacting across the network 640. Similarly, the term PLC as used herein can include functionality that can be shared across multiple components, systems, and or networks 640. For example, one or more PLCs can communicate and cooperate with various network devices across the network 640. This can include substantially any type of control, communications module, computer, I/O device, sensor, Human Machine Interface (HMI)) such as the user interface 630 that communicate via the network 640 which includes control, automation, and/or public networks. The PLC can also communicate to and control various other devices such as Input/Output modules including Analog, Digital, Programmed/Intelligent I/O modules, other programmable controllers, communications modules, sensors, output devices, and the like.

The network 640 can include public networks such as the Internet, Intranets, and automation networks such as Control and Information Protocol (CIP) networks including DeviceNet and ControlNet. Other networks include Ethernet, DH/DH+, Remote I/O, Fieldbus, Modbus, Profibus, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

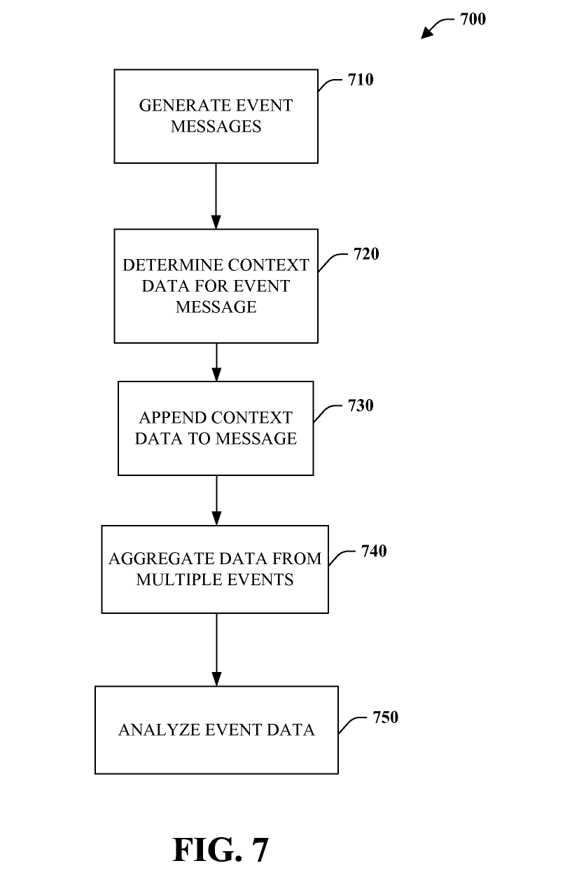

FIG. 7 illustrates a context data annotation process 700 for an industrial automation system. While, for purposes of simplicity of explanation, the methodology is shown and described as a series of acts, it is to be understood and appreciated that the methodology is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as described herein.

Proceeding to 710 of FIG. 7, event messages are generated. These can include events such as alarms or other messages that are generated such as a result of process control variable being out of range. At 720, context data is determined for the respective events generated at 710. This can include automated processes such as the PLC determining which portion of a batch or recipe that was executing when the event message was generated. Users can determine context such as generating comments describing an event that can later be analyzed.

At 730, the context data determined at 720 is appended or added to the event message generated at 710. This can include automatic appendages such as via a PLC controller and/or include manual annotations such as a user interface that can process the event message from a network database or other component. At 740, event messages are aggregated into a database or other storage medium. From such database, various forms of analysis and tools can be applied at 750. This can include report generators that provide reports based on one or more queries or filter conditions. Analysis can also include substantially any type of software post processing that is applied to the aggregated data including data mining tools.

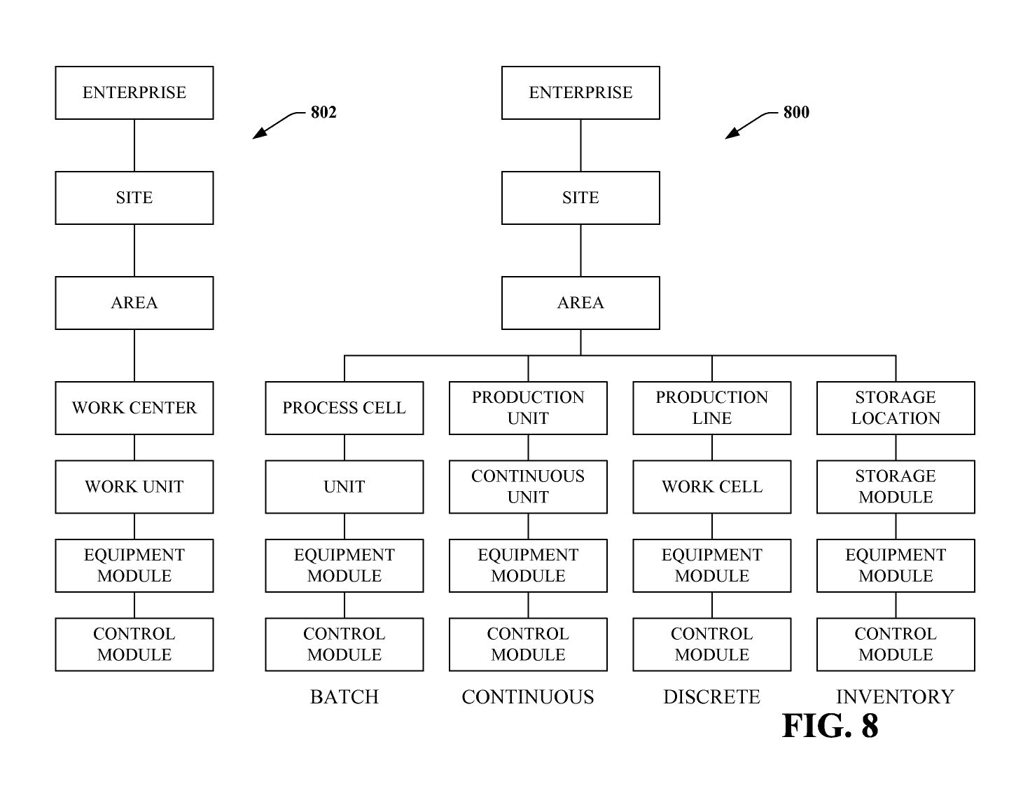

FIGS. 8-11 illustrate aspects of a common data model noted above that can be employed as part of an annotation chain for processing event messages. Thus, depending at what portion of the data model that an event message has been processed or been exposed to, annotations for such exposure to the model can be automatically generated and applied as context data from one or more portions of the model. For example, if an event message had traveled though an area computer or database, an work center computer or database, an equipment module and so forth, context data could be added for one or more of the portions or layers that the event message had been processed by in accordance with the various components of the common data model as described in more detail below with respect to FIGS. 8-11.

Now turning to FIG. 8, hierarchical representations that can be employed in connection with a schema employed by programmable logic controllers to facilitate use of a hierarchically structured data model are illustrated. The hierarchies illustrated in this figure relate to equipment hierarchies, which can be integrated with procedure hierarchies to generate a robust representation of An enterprise (which is incorporated within a schema for use in connection with industrial controllers and event message processing). A first hierarchy 800 illustrates a representation of equipment within a plant given disparate processes. For instance, a hierarchy in accordance with a batch process can include a representation of an enterprise, site, area, process cell, unit, equipment module, and control module. In contrast, a hierarchical representation of equipment within a continuous process can include representations of an enterprise, site, area, production unit, continuous unit, equipment module, and control module. In still more detail, an enterprise can represent an entirety of a company, a site can represent a particular plant, an area can represent a portion of the plant, a process cell can include equipment utilized to complete a process, a unit can relate to a unit of machinery within the process cell, an equipment module can include a logical representation of portions of the unit, and the control module can include basic elements, such as motors, valves, and the like. Furthermore, equipment modules can include equipment modules and control modules can include control modules. Thus, as can be discerned from the figure, four disparate hierarchical representations can be employed to represent equipment within batch processes, continuous processes, discrete processes, and inventory.

A second hierarchy 802 can be utilized that represents each of the aforementioned hierarchical representations. The hierarchy 802 can include representations of an enterprise, a site, an area, a work center, a work unit, an equipment module, and a control module. Thus, a common representation can be generated that adequately represents the hierarchy 800. For purposes of consistent terminology, data objects can be associated with metadata indicating which type of process they are associated with. Therefore, data objects can be provided to an operator in a form that is consistent with normal usage within such process. For example, batch operators can utilize different terminology than a continuous process operator (as shown by the hierarchy 800). Metadata can be employed to enable display of such data in accordance with known, conventional usage of such data. Thus, implementation of a schema in accordance with the hierarchy 802 will be seamless to operators. Furthermore, in another example, only a portion of such representation can be utilized in a schema that is utilized by a controller. For instance, it may be desirable to house equipment modules and control modules within a controller. In another example, it may be desirable to include data objects representative of work centers and work units within a controller (but not equipment modules or control modules). The claimed subject matter is intended to encompass all such deviations of utilizing the hierarchy 802 (or similar hierarchy) within a controller.

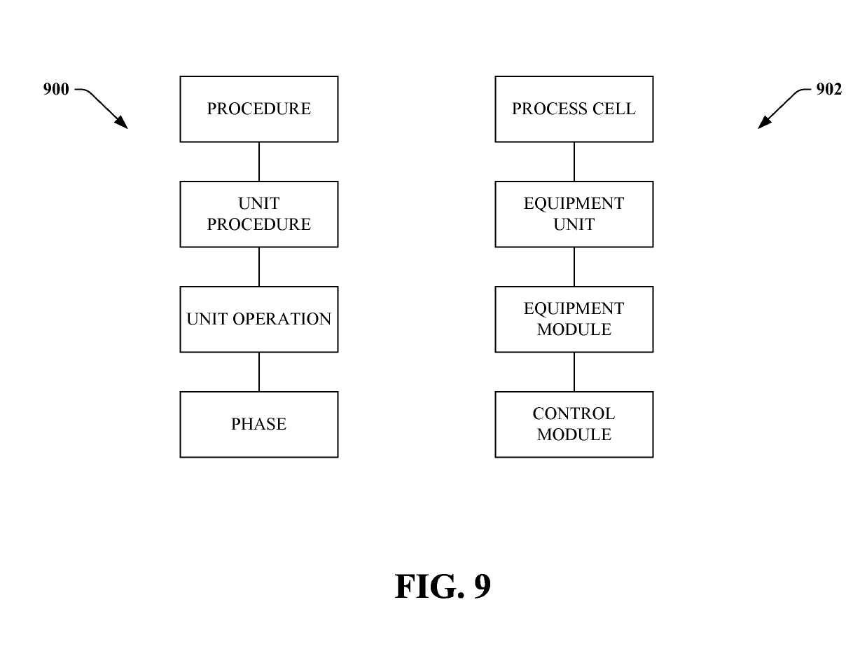

Referring to FIG. 9, standard hierarchies that can be utilized to represent procedures and equipment are illustrated. In particular, a hierarchy 900 represents procedures that can exist within a batch process. For instance, a procedure can relate to a high-level procedure, such as creation of a pharmaceutical drug, where such procedure data can be employed as context data. A unit procedure can be more specific, such as adding particular chemicals to a mix by way of a particular unit. A unit operation can be still more specific, and a phase can be yet more specific (relating to operation of low-level machines). For instance, a phase can relate to various states which can exist with respect to low-level equipment, such as stopping, starting, pausing a motor, opening and closing a valve, and the like. A hierarchy 902 relating to a representation of equipment in, for example, a batch process is displayed adjacent to the hierarchy 900.

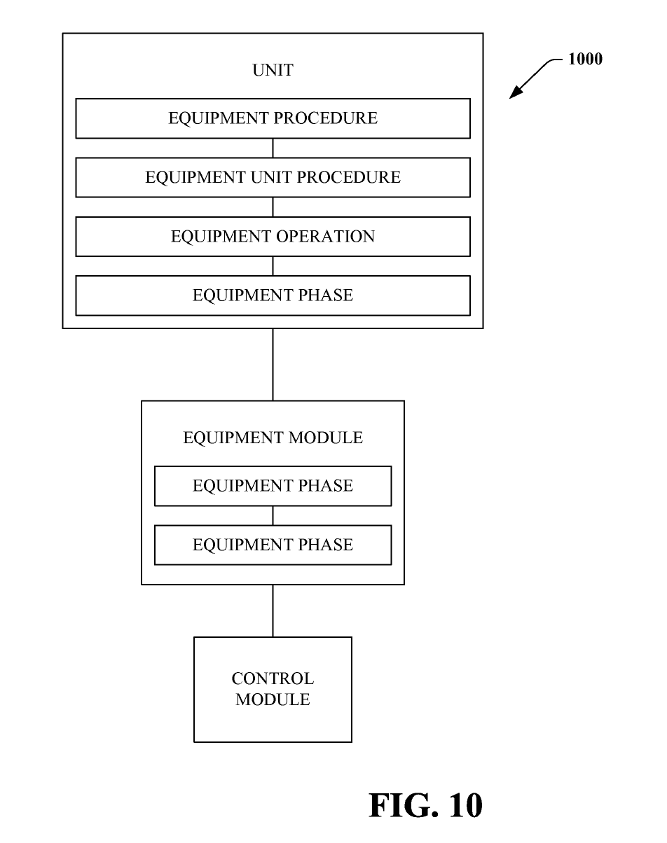

Turning to FIG. 10, a hierarchy 1000 that represents one possible integration of the example hierarchies 900 and 902 (FIG. 9). A unit (such as a work unit described in FIG. 8) can be associated with a procedure, a unit, an operation, and an equipment phase). Thus, the procedures, operation, and phase can be associated with a particular work unit. An equipment phase can be associated with one or more equipment modules, and can be above a control module in the hierarchy.

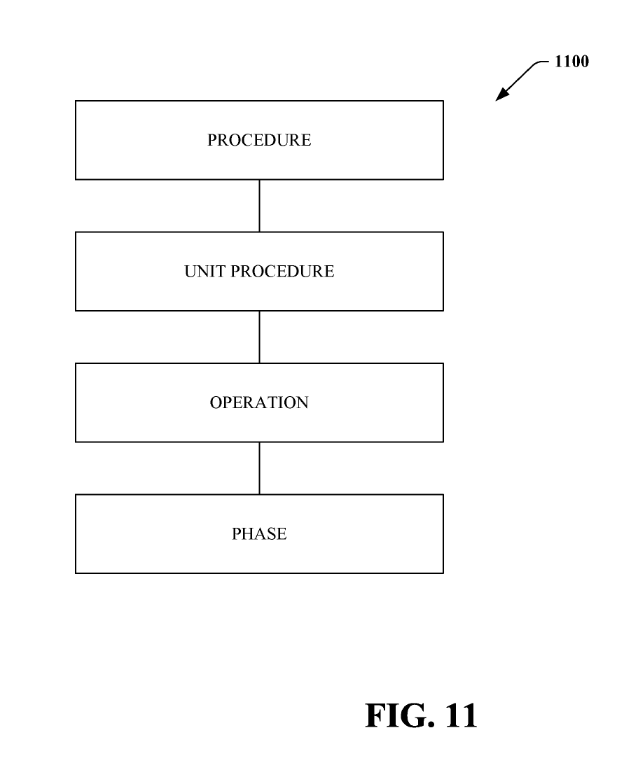

Referring Briefly to FIG. 11, a hierarchy 1100 that can be utilized in connection with equipment control is illustrated. The hierarchy is substantially similar to that described above. As stated above, the hierarchies illustrated in FIGS. 8-11 can be based upon a standard, such as ISA 88, ISA 95, or other standard. Any suitable representation that can be utilized to model an entirety of a plant, however, is contemplated. Further, the representations shown in these figures can be directly implemented into a controller. For instance, data objects in accordance with any portion of the hierarchies described in FIGS. 8-11 can be existent within a controller, together with state machines that enable creation of such objects.

It is noted that the above messages and context data can be processed on various types of computing devices and resources, where some of these devices may be associated with an industrial control component and other devices associated with standalone or networked computing devices. Thus, computers can be provided to execute the above messages or associated data that include a processing unit, a system memory, and a system bus, for example. The system bus couples system components including, but not limited to, the system memory to the processing unit that can be any of various available processors. Dual microprocessors and other multiprocessor architectures also can be employed as the processing unit. Computers can operate in a networked environment using logical connections to one or more remote computers, such as remote computer(s). The remote computer(s) can be a personal computer, a server, a router, a network PC, a workstation, a microprocessor based appliance, a peer device or other common network node and the like, and typically includes many or all of the elements described relative to computer. Remote computers can be logically connected through a network interface and then physically connected via communication connection.

The systems described above employing the context data can include one or more client(s). The client(s) can be hardware and/or software (e.g., threads, processes, computing/control devices). The systems can also include one or more server(s). The server(s) can also be hardware and/or software (e.g., threads, processes, computing/control devices). The servers can house threads to perform transformations by employing the authentication protocol, for example. One possible communication between a client and a server may be in the form of a data packet adapted to be transmitted between two or more computer processes.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A data processor for an industrial automation system, comprising:
an event component to generate an initial message from an industrial control system component, the initial message based in part on one or more automatically detected conditions; and
a context component to enable data to be added to the initial message to facilitate post processing of system events.

2. The data processor of claim 1, further comprising one or more control system components to generate the initial message.

3. The data processor of claim 2, the control system components include a programmable logic controller, an I/O module, an I/O device, a communications module, or a network device.

4. The data processor of claim 2, the control system component drives a context component to append data to the initial message.

5. The data processor of claim 4, further comprising a user interface to drive the context component.

6. The data processor of claim 1, further comprising an aggregator to collect a plurality of event messages.

7. The data processor of claim 6, further comprising a report generation component to provide reports from the plurality of event messages.

8. The data processor of claim 6, the report generation component further comprising a query component or a filter component to provide the report.

9. The data processor of claim 6, further comprising a data analysis component to process the plurality of event messages.

10. The data processor of claim 9, the data analysis component includes an Online Analytical Processing component.

11. The data processor of claim 1, the initial message is associated with an alarm or process detected condition.

12. The data processor of claim 1, the initial message is processed over a network and according to concurrent or different times.

13. The data processor of claim 1, the initial message is supplemented with an activity type, user identification, or function.

14. The data processor of claim 13, the initial message is supplemented with source information, program information, step information, phase information, batch information, or recipe information.

15. The data processor of claim 13, the initial message is supplemented with data associated with a common data model representing an enterprise hierarchy.

16. The data processor of claim 1, further comprising a component to display all alarms or subset of alarms relating to one context while hiding alarm data related to another context.

17. The data processor of claim 1, the context component is employed to append user identification data to the initial message.

18. The data processor of claim 1, further comprising an event processor to generate events or alarms.

19. The data processor of claim 18, the event processor employs one or more internal conditions to generate the events.

20. The data processor of claim 19, the internal conditions are associated with statistical processes, probabilities, program variables, inference conditions, or processor detected diagnostics.

21. The data processor of claim 19, the event processor is driven from one or more external conditions to a processor, external commands, range data, fault data, or maintenance data.

22. A computer readable medium having computer executable instructions stored thereon to facilitate event processing in an industrial automation environment, comprising:
generating at least one event in a control system;
providing a base annotation to the event including a time, a name or an address; and
applying a supplemental annotation to the event via a control system component or a user interface.

23. The computer readable medium of claim 22, aggregating a plurality of events for the control system.

24. The computer readable medium of claim 23, further comprising automatically generating a report from the plurality of events.

25. The computer readable medium of claim 23, further comprising performing a data mining analysis on the plurality of events.

26. A method to annotate industrial control events, comprising:
generating one or more events in an industrial control system;
determining a context for the one or more events; and
appending the context to one or more messages associated with the events.

27. The method of claim 26, further comprising aggregating the one or more messages associated with the events.

28. The method of claim 27, the further comprising generating a report or performing data analysis from the one or more messages associated with the events.

29. A data generator for an industrial control system, comprising:
means for generating at least one event condition in an industrial control system;
means for supplementing the alarm or event condition with context data; and
means for aggregating the context data in the industrial control system.

30. The system of claim 29, further comprising means for generating a report in the industrial control system from the context data.
